(19) United States
(12) Patent Application Publication
(10) Pub. No.: US 2017/0190299 A1
(43) Pub. Date: Jul. 6, 2017

(54) RETRACTABLE BICYCLE CARRIER

(71) Applicant: FORD GLOBAL TECHNOLOGIES, LLC, Dearborn, MI (US)

(72) Inventor: Omar Molina, Mexico City (MX)

(21) Appl. No.: 14/987,232

(22) Filed: Jan. 4, 2016

(51) Int. Cl. B60R 9/06; B60R 9/10

(52) U.S. Cl. CPC B60R 9/06; B60R 9/10

(57) ABSTRACT

A bicycle carrier system for a vehicle includes a rail assembly configured for translation between a stored position within a vehicle fascia and a fully deployed position. The rail assembly includes one or more sliding rails each carrying a plurality of pivoting anchors. An actuable retainer is provided to selectively hold the one or more sliding rails in the fully deployed position and the stored position. A biasing member is included for biasing each of the one or more sliding rails to at least a partially deployed position. One or more cooperating tracks associated with a portion of a vehicle frame are provided for receiving the one or more sliding rails.

### TECHNICAL FIELD

This disclosure relates generally to accessory racks for motor vehicles, and more particularly to a retractable bicycle carrier for transporting a bicycle.

### BACKGROUND

A variety of exterior bicycle carriers are commercially available, including roof-mounted carriers, rear hatch or trunk-mounted carriers, vacuum-mounted carriers, and hitch-mounted carriers. Each is substantially effective for its intended purpose. However, roof-mounted and hitch-mounted carriers require that the vehicle be originally equipped or retrofitted with features such as roof rails or a hitch box to which the carrier may be attached. Moreover, attaching bicycles to roof-mounted carriers in areas where height restrictions apply, such as tunnels, parking garages, home garages, etc. having a low roof height may result in damage to the bicycles and/or the vehicle body. Rear hatch or trunk-mounted carriers and vacuum-mounted carriers are typically removed when a bicycle is not being transported, and so risk damage to the vehicle paint and body parts. Therefore, a need is identified for a bicycle carrier for a vehicle that lacks these disadvantages.

To solve these and other problems, the present disclosure relates to a retractable bicycle carrier system. Advantageously, the described system can be retracted into a portion of the vehicle, and thus does not impact vehicle styling when not in use to carry bicycles. Still more, the described system advantageously allows access to a vehicle cargo area such as a trunk or the rear cargo area of a sport utility vehicle (SUV), cross-over utility vehicle (CUV), van, etc. even when bicycles are being transported. In turn, the described system does not impact available vehicle cargo area space when bicycles are being transported.

### SUMMARY

In accordance with the purposes and benefits described herein, in one aspect a bicycle carrier system for a vehicle is provided, comprising a rail assembly configured for translation between a stored position within a vehicle fascia and a fully deployed position. The rail assembly may include one or more sliding rails each carrying a plurality of pivoting anchors and fasteners. In embodiments, an actuable retainer may be provided to selectively hold the one or more sliding rails in the fully deployed position and the stored position. A biasing member may be included for biasing each of the one or more sliding rails to at least a partially deployed position. One or more cooperating tracks are associated with a portion of a vehicle frame for receiving the one or more sliding rails.

In embodiments, the actuable retainer is a locking solenoid and the biasing member is a spring. An actuator may be provided for the retainer, associated with one or more of a vehicle passenger cabin element, a key fob, and a smartkey. In embodiments, each of the one or more sliding rails includes one or more recesses for receiving the plurality of pivoting anchors and fasteners when the sliding rails are in the stored position. The described system may further include one or more sensors associated with at least one of the one or more sliding rails, selected from one or more of an obstacle-detecting sensor and a contact sensor.

In another aspect, a bicycle carrier system for a vehicle is described comprising a rail assembly configured for translation between a stored position within a vehicle fascia and a fully deployed position, the rail assembly comprising two or more sliding rails each carrying a plurality of pivoting anchors and fasteners. An actuable retainer is provided for selectively holding the two or more sliding rails in the fully deployed position and the stored position. A biasing member is provided for biasing each of the two or more sliding rails to at least a partially deployed position. Two or more cooperating tracks associated with a portion of a vehicle frame are provided for receiving the two or more sliding rails.

In embodiments, the actuable retainer is a locking solenoid. In embodiments, each of the two or more sliding rails includes one or more recesses for receiving the plurality of pivoting anchors and fasteners when in the stored position. An actuator for the retainer may be provided, associated with one or more of a vehicle passenger cabin element, a key fob, and a smartkey. The described system may further include one or more sensors associated with at least one of the two or more sliding rails, selected from one or more of an obstacle-detecting sensor and a contact sensor.

In yet another aspect, a bicycle carrier system for a vehicle is described, comprising a rail assembly configured for translation between a stored position within a vehicle fascia and a fully deployed position. The sliding rail assembly comprises a pair of sliding rails each carrying a plurality of pivoting anchors and fasteners and a pair of cooperating tracks associated with a portion of a vehicle frame. A locking solenoid is included for selectively holding the pair of sliding rails in the fully deployed position and in the stored position. In turn, springs are provided configured to bias each of the pair of sliding rails to at least a partially deployed position. The described system may further include one or more sensors associated with at least one of the pair of sliding rails, selected from one or more of an obstacle-detecting sensor and a contact sensor. Each of the one or more sliding rails may include one or more recesses for receiving the plurality of pivoting anchors and fasteners when in the stored position.

In the following description, there are shown and described embodiments of the disclosed retractable bicycle carrier system. As it should be realized, the system is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed retractable bicycle carrier system, and together with the description serve to explain certain principles thereof. In the drawing:

FIG. 1 depicts a vehicle including the retractable bicycle carrier system of the present disclosure in a stored position;

FIG. 2 depicts the retractable bicycle carrier system of FIG. 1 in a fully deployed position;

FIG. 3 depicts a track system for the described retractable bicycle carrier system;

FIG. 4A depicts a sliding rail of the retractable bicycle carrier system in a stored position;

FIG. 4B depicts the sliding rail of FIG. 4A in a partially deployed position;

FIG. 4C depicts the sliding rail of FIG. 4A in a fully deployed position; and

FIG. 5 depicts a pair of bicycles carried on the described retractable bicycle carrier system.

Reference will now be made in detail to embodiments of the disclosed retractable bicycle carrier system, examples of which are illustrated in the accompanying drawing figures.

### DETAILED DESCRIPTION

Preliminarily, the present disclosure primarily describes a retractable bicycle carrier system used in association with a rear fascia of a sedan. However, the skilled artisan will appreciate that the described system is readily adaptable to any vehicle such as an SUV, a CUV, a van, a pickup truck, and the like having a bumper-covering fascia, and could even be used in association with a front fascia in the proper circumstances, i.e. when the vehicle style admits of sufficient clearance to prevent the carried bicycles from impeding a driver's field of view. Accordingly, the descriptions and drawings that follow will not be taken as limiting in regard to the above-described features.

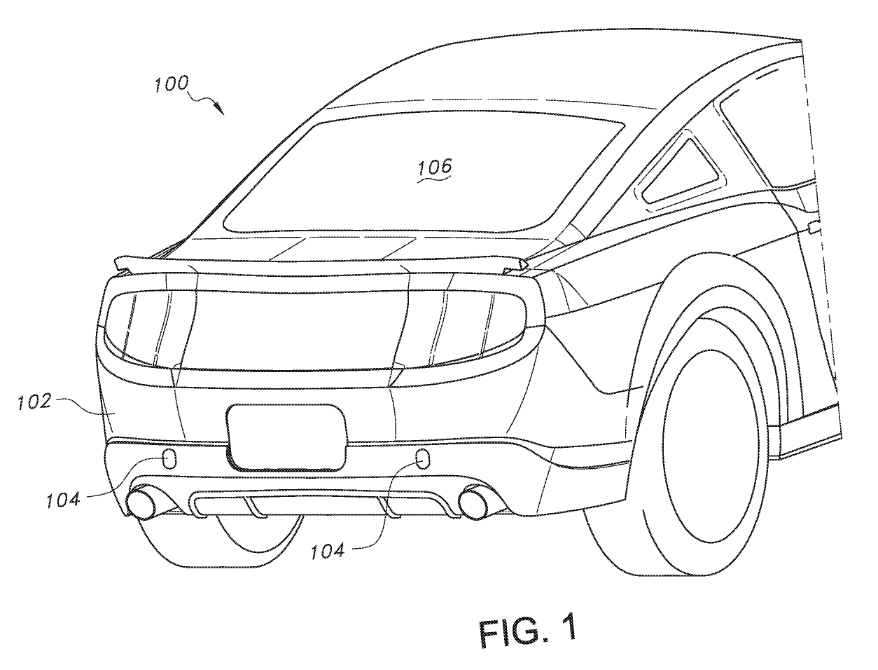

FIG. 1 depicts a vehicle 100 including a bicycle carrier system (not visible in this view) according to the present disclosure. As depicted in the drawing, the bicycle carrier system is in a stored position, disposed within a fascia 102 of the vehicle 100. As will be appreciated, by within a fascia 102 is meant disposed substantially in an interior thereof for storage. As depicted, covers 104 are provided to present a substantially flush appearance to the fascia 102 when the carrier system is stored. However, in alternative embodiments such covers could be omitted, or alternatively the carrier system may not retract completely within a perimeter defined by the fascia 102.

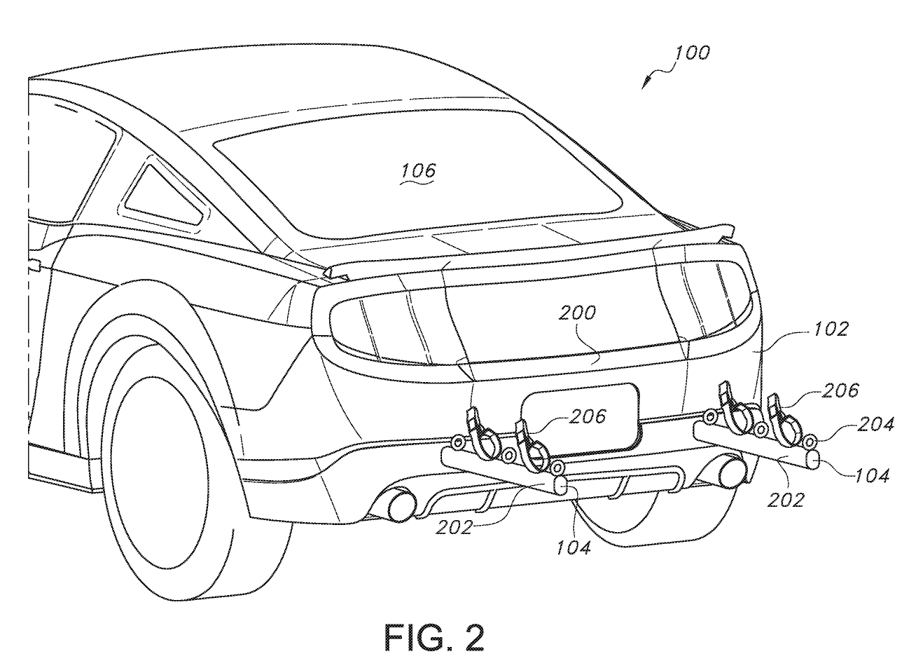

FIG. 2 shows the bicycle carrier system 200 of the disclosure, in a fully deployed position. In the depicted embodiment, the system 200 includes a pair of spaced-apart sliding rails 202 configured for translation between the stored position of FIG. 1 and the deployed position of FIG. 2 as will be described. However, it is contemplated to provide a bicycle carrier system 200 including fewer or more spaced apart rails 202, in accordance with the number, weight, etc. of bicycles (not shown in this view) to be carried. The spaced-apart rails 202 include a number of pivoting anchors 204 and bicycle fasteners 206.

In the depicted embodiment, the pivoting anchors 204 are pivoting rings and the fasteners 206 are straps configured for capturing a bicycle tire and rim. However, alternative configurations are known for such pivoting anchors and fasteners, and such are contemplated for use herein. Advantageously, the pivoting anchors 204 and bicycle fasteners 206 are configured to fold either flush with or into an interior of the sliding rails 202. As will be appreciated, this allows convenient storage of these features when the system 200 is not used to carry bicycles, especially when the sliding rails 202 are retracted into the stored position shown in FIG. 1.

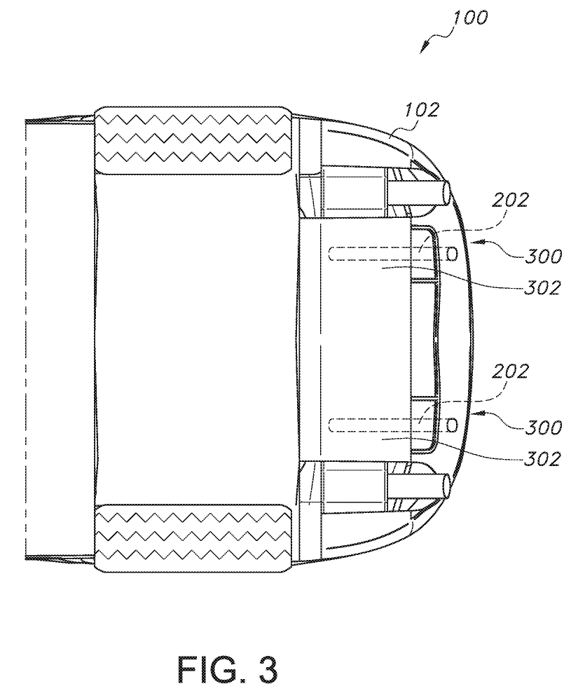

With reference to FIG. 3, the carrier system 200 further includes one or more cooperating tracks 300 dimensioned to slidingly receive the sliding tracks 202. In the depicted embodiment the cooperating tracks 300 are associated with a frame 302 of the vehicle 100, although alternative placements are possible and contemplated. The system of claim 1, further including one or more cooperating tracks associated with a portion of a vehicle frame for receiving the one or more sliding rails. Various embodiments of the sliding rail 202/cooperating track 300 are contemplated. For example, the rails may slide within the tracks using a drawer slide-type mechanism of a type well known in the art wherein one of the rail or track includes bearings or rollers to reduce friction and ensure smooth operation. Alternatively, a smooth sliding movement of the rails 202 within the tracks 300 may be achieved by use of suitable lubricants. Such mechanisms are well known to the skilled artisan, for example in the cabinetry and/or drawer slide arts, and do not require detailed description herein.

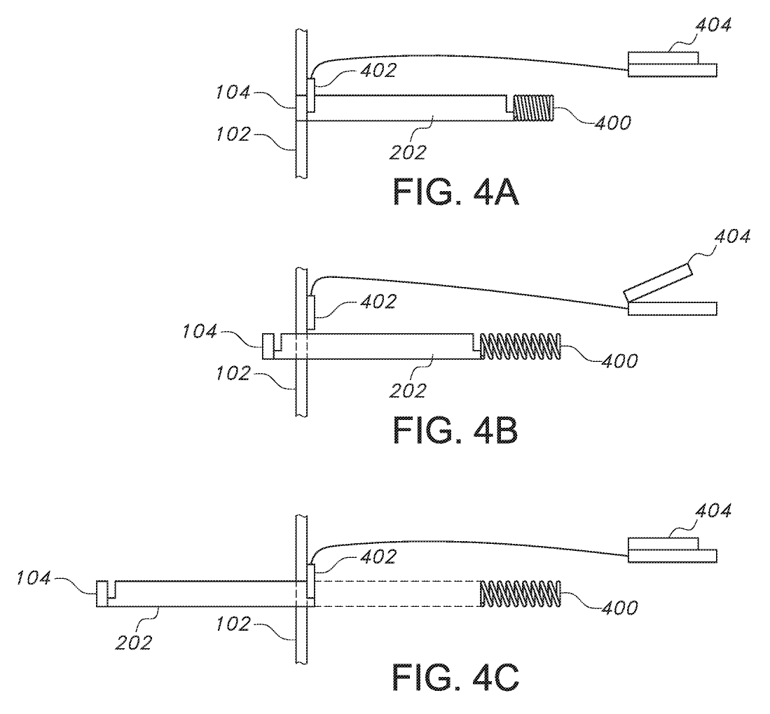

FIGS. 4A-4C illustrate an embodiment of a control mechanism for the sliding rails 202 allowing translation of the rails between the stored position of FIG. 1 and the fully deployed position of FIG. 2. As shown, a biasing member 400 is provided at an end of each sliding rail 202. In the depicted embodiment, biasing member 400 is a pre-load spring. However, numerous alternative biasing members 400 could be provided, including without intending any limitation linear actuators such as gas or hydraulic cylinders, arcuate leaf springs, and others.

An actuable retainer 402 is included for selectively retaining the sliding rails 202 in the stored position of FIG. 1 and the fully deployed position of FIG. 2. In the depicted embodiment, the actuable retainer 402 is a locking solenoid of known design, although alternative retainers such as spring-loaded pins would be suitable and are contemplated for use herein. An actuator 404 is provided for the actuable retainer 402, which may be a switch disposed in the passenger cabin 106, for example in association with the dash panel (not shown) or a door panel (not shown). Alternatively or in addition, an actuator may be provided in association with a vehicle key (not shown), such as a key fob, a smart key, or others.

In use, as shown in FIG. 4A in the stored position the sliding rail 202 is fully retracted within the fascia 102, and the biasing member 400 is compressed. The actuable retainer 402 engages the sliding rail 202 to hold it in the stored position. On actuation of the actuable retainer 402 by actuator 404, the actuable retainer 402 disengages from the sliding rail 202, and the biasing member 400 urges the sliding rail 202 to a partially deployed position (see FIG. 4B). In this position, a user need only grasp an end of the sliding rail 202 and pull to translate the rail to the fully deployed position shown in FIG. 4C. In that fully deployed position, as shown the actuable retainer 402 re-engages the sliding rail 202, thus holding the rail in the fully deployed position for use. Of course, to retract the sliding rail 202 a user simply reverses the process by actuating the retainer 402 to release the rail, pushing the rail back along cooperating tracks 300 (not shown in this view) into the fascia 102, and re-engaging the rail 202 with the retainer 402 to hold the rail in the stored position of FIG. 4A. At the same time, the biasing member 400 is again compressed, pre-loading the biasing member for the next deploying operation.

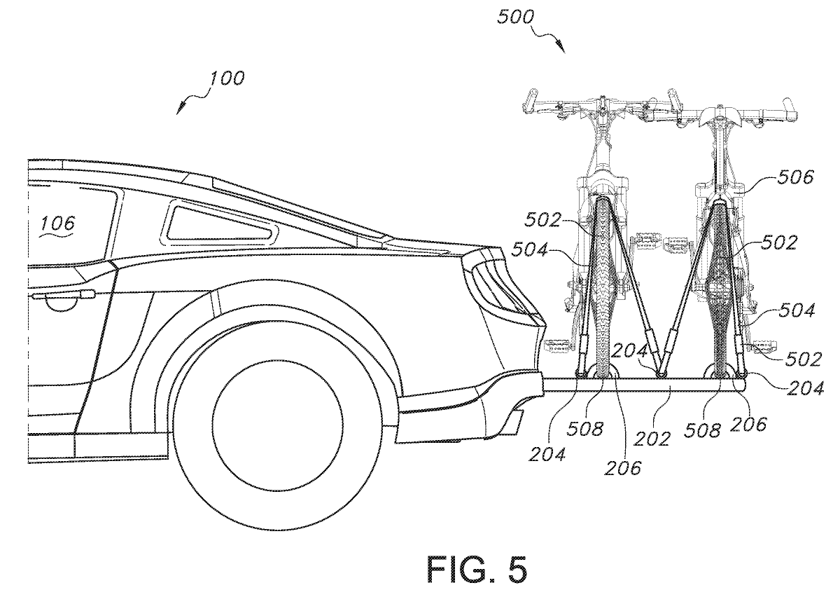

Once the retractable carrier system 200 is in the deployed position, one or more bicycles 500 may be attached thereto (see FIG. 5). As shown, fasteners 206 are used to secure the bicycle tires 502 to the sliding rails 202. In turn, straps 504 are attached at one end to pivoting anchors 204 and also to the bicycle frame 504 or to another element of the bicycle, thus maintaining the bicycles 500 in an upright position for carrying. Any suitable strap 504 is contemplated, for example a ratcheting strap of known design.

Optionally, one or more contact sensors 508 may be included on a portion of sliding rails 202 that will be contacted by one or both bicycle tires 502. A number of suitable contact sensor 508 designs are known, including without intending any limitation pressure switches, contact switches, or more complex mechanisms. As will be appreciated, such contact sensors 508 detect the presence of a bicycle 500 carried on the carrier system 200, and can be configured to emit an audible warning to alert a user that an attempt is being made to retract the system 200 with a bicycle 500 carried thereon. Alternatively or additionally, the contact sensors 508 may be configured to disable the actuable retainer 402, thus preventing retraction of the system 200 to the stored position when a bicycle 500 is carried on the sliding rails 202.

Of course, additional features may be included. For example, the retractable bicycle carrier system 200 may be equipped with an obstacle-detecting or “back-up” sensor system of a type well known in the art, utilizing as non-limiting examples one or more technologies such as ultrasound, cameras, laser, lidar, etc. to detect an obstacle approaching or being approached by the vehicle. As is known, such obstacle-detecting sensors emit a visual and/or audible warning tone when a vehicle is approaching an obstacle, or vice versa. In an embodiment (see FIG. 5), backup sensors 510 are disposed in a terminal end of one or both of the sliding rails 202. By such sensors, damage to bicycles carried by the described retractable bicycle carrier system caused by backing into an obstacle may be avoided.

Obvious modifications and variations are possible in light of the above teachings. All such modifications and variations are within the scope of the appended claims when interpreted in accordance with the breadth to which they are fairly, legally and equitably entitled.

What is claimed:

1. A bicycle carrier system for a vehicle, comprising a rail assembly configured for translation between a stored position within a vehicle fascia and a fully deployed position;
wherein the rail assembly comprises one or more sliding rails each carrying a plurality of pivoting anchors and fasteners.

2. The system of claim 1, further including an actuable retainer for selectively holding the one or more sliding rails in the fully deployed position and the stored position.

3. The system of claim 1, further including a biasing member for biasing each of the one or more sliding rails to at least a partially deployed position.

4. The system of claim 2, wherein the actuable retainer is a locking solenoid.

5. The system of claim 1, wherein each of the one or more sliding rails includes one or more recesses for receiving the plurality of pivoting anchors and fasteners when in the stored position.

6. The system of claim 1, further including one or more cooperating tracks associated with a portion of a vehicle frame for receiving the one or more sliding rails.

7. The system of claim 3, further including an actuator for the retainer, associated with one or more of a vehicle passenger cabin element, a key fob, and a smartkey.

8. The system of claim 7, further including one or more sensors associated with at least one of the one or more sliding rails, selected from one or both of an obstacle-detecting sensor and a contact sensor.

9. A motor vehicle including the system of claim 1.

10. A bicycle carrier system for a vehicle, comprising:
a rail assembly configured for translation between a stored position within a vehicle fascia and a fully deployed position, the rail assembly comprising two or more sliding rails each carrying a plurality of pivoting anchors and fasteners;
an actuable retainer for selectively holding the two or more sliding rails in the fully deployed position and the stored position; and
a biasing member for biasing each of the two or more sliding rails to at least a partially deployed position.

11. The system of claim 10, wherein the actuable retainer is a locking solenoid.

12. The system of claim 10, wherein each of the two or more sliding rails includes one or more recesses for receiving the plurality of pivoting anchors and fasteners when in the stored position.

13. The system of claim 10, further including two or more cooperating tracks associated with a portion of a vehicle frame for receiving the two or more sliding rails.

14. The system of claim 10, further including an actuator for the retainer, associated with one or more of a vehicle passenger cabin element, a key fob, and a smartkey.

15. The system of claim 14, further including one or more sensors associated with at least one of the one or more sliding rails, selected from one or both of an obstacle-detecting sensor and a contact sensor.

16. A motor vehicle including the system of claim 10.

17. A bicycle carrier system for a vehicle, comprising:
a rail assembly configured for translation between a stored position within a vehicle fascia and a fully deployed position, the sliding rail assembly comprising a pair of sliding rails each carrying a plurality of pivoting anchors and fasteners and a pair of cooperating tracks associated with a portion of a vehicle frame;
a locking solenoid for selectively holding the pair of sliding rails in the fully deployed position and in the stored position; and
springs configured for biasing each of the pair of sliding rails to at least a partially deployed position.

18. The system of claim 17, further including one or more sensors associated with at least one of the pair of sliding rails, selected from one or both of an obstacle-detecting sensor and a contact sensor.

19. The system of claim 17, wherein each of the pair of sliding rails includes one or more recesses for receiving the plurality of pivoting anchors and fasteners when in the stored position.

20. A motor vehicle including the system of claim 17.
